(19) United States
(12) Patent Application Publication
(10) Pub. No.: US 2016/0103009 A1
(43) Pub. Date: Apr. 14, 2016

(54) FUEL LEVEL SENSOR

(71) Applicant: GM GLOBAL TECHNOLOGY OPERATIONS LLC, DETROIT, MI (US)

(72) Inventors: Jeffery J. Milton, Lake Orion, MI (US); Kristin M. DeMare, Rochester Hills, MI (US); William L. Villaire, Clarkston, MI (US)

(21) Appl. No.: 14/511,297

(22) Filed: Oct. 10, 2014

(51) Int. Cl. G01F 23/36

(52) U.S. Cl. CPC G01F 23/36

(57) ABSTRACT

A fuel tank system for use in a vehicle comprises a fuel tank having a volume comprising a first or primary range and a second or preliminary range. A fuel level sensor assembly disposed in the fuel tank comprises a receiving unit, a first fuel level sensor positioned to move with the level of fuel in the first or primary range of the fuel and a second fuel level sensor positioned to move with the level of fuel in the second or preliminary range of the fuel. The receiving unit delivers a signal to a control module that indicates that the fuel level is within the preliminary range or the primary range.

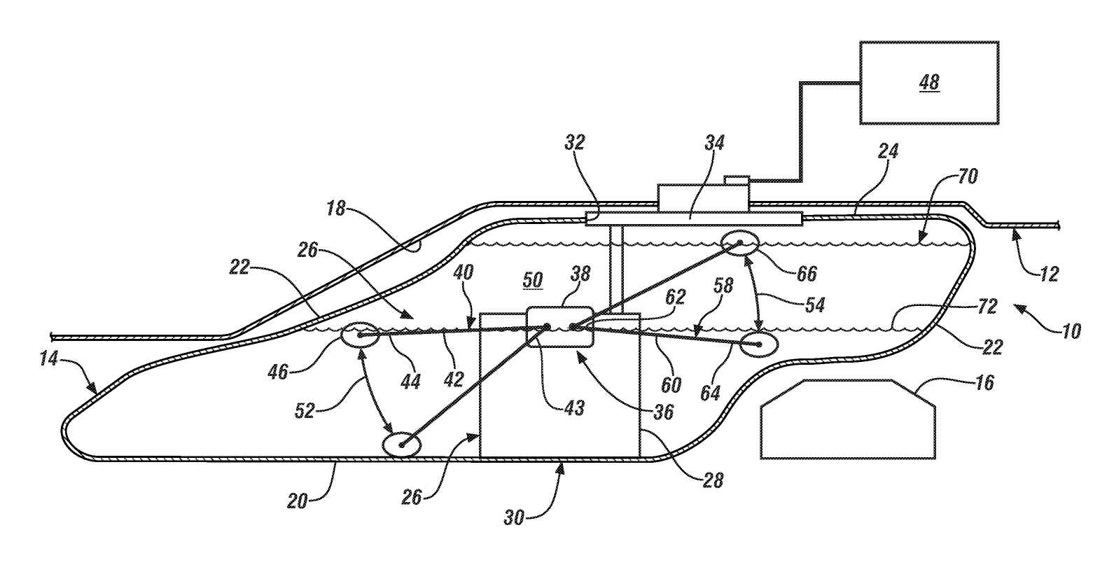

### FIELD OF THE INVENTION

The subject invention is related to the fuel tank system of a vehicle and, more particularly, to a fuel tank system having a fuel level sensor that reduces the volume of unreadable fuel.

### BACKGROUND

Fuel tank systems are used to store fuel in vehicles typically for consumption by an internal combustion engine. In some vehicles, due to packaging limitations or the desire to increase the capacity of fuel for the purpose of extending vehicle range, fuel tanks may be configured with geometries that defy simple fuel level monitoring. Typically, fuel level monitoring is achieved using a fuel sensing unit that comprises a swing arm having a proximal end pivotally attached to a base or receiving unit and a distal end having a float member attached thereto. The float member rises and falls with the level of fuel causing the swing arm to move. The receiving unit is signally attached to a control module that determines the fuel level from a received signal. Some fuel tank geometries may not allow for a fuel sensing unit of the type described to accurately measure the fuel level in the tank simply due to the fact that the swing arm is unable to move in a manner that represents the full range of the fuel volume from full to empty. The result of such a tank geometry may be the existence of unmeasurable zones which result in inconsistent fuel gage movement during vehicle operation (ex. long duration to half, short duration to empty). It is desirable to achieve a consistent movement of the fuel gage during vehicle operation regardless of the fuel tank geometry.

### SUMMARY

In one exemplary embodiment a fuel tank system for use in a vehicle comprises a fuel tank having a volume comprising a first or primary range and a second or preliminary range. A fuel level sensor assembly disposed in the fuel tank comprises a receiving unit, a first fuel level sensor positioned to move with the level of fuel in the first or primary range of the fuel and a second fuel level sensor positioned to move with the level of fuel in the second or preliminary range of the fuel. The receiving unit delivers a signal to a control module that indicates that the fuel level is within the preliminary range or the primary range.

In another exemplary embodiment a fuel tank system for use in a vehicle comprises a fuel tank having a fuel volume comprising a first or primary range and a second or preliminary range. A fuel pump assembly is disposed in the fuel tank and comprises a main body and a fuel level sensor assembly. The fuel level sensor assembly comprises a receiving unit, a first fuel level sensor positioned to move with the level of fuel in the first or primary range of the fuel and a second fuel level sensor positioned to move with the level of fuel in the second or preliminary range of the fuel, wherein the receiving unit delivers a signal to a control module that indicates that the fuel level is within the preliminary range or the primary range.

In yet another exemplary embodiment, a vehicle having a fuel tank system comprises a fuel tank having a fuel volume comprising a first or primary range and a second or preliminary range. A fuel pump assembly is disposed in the fuel tank and comprises a main body and a fuel level sensor assembly. The fuel level sensor assembly comprises a receiving unit, a first fuel level sensor positioned to move with the level of fuel in the first or primary range of the fuel and a second fuel level sensor positioned to move with the level of fuel in the second or preliminary range of the fuel, wherein the receiving unit delivers a signal to a control module that indicates that the fuel level is within the preliminary range or the primary range.

The above features and advantages, and other features and advantages of the invention, are readily apparent from the following detailed description of the invention when taken in connection with the accompanying drawing.

### BRIEF DESCRIPTION OF THE DRAWING

Other features, advantages and details appear, by way of example only, in the following detailed description of embodiments, the detailed description referring to the sole FIGURE which is a schematic, cross-sectional view of a fuel tank system embodying features of the invention.

### DESCRIPTION OF THE EMBODIMENTS

The following description is merely exemplary in nature and is not intended to limit the present disclosure, its application or uses. As used herein, the term vehicle is not limited to just an automobile, truck, van or sport utility vehicle, but includes any self-propelled or towed conveyance suitable for transporting a burden.

Referring to the FIGURE, a fuel tank system 10 is illustrated for use in a vehicle 12. The fuel tank system 10 includes a fuel tank 14 having an oblong, non-traditional configuration. Fuel tanks 14 of the configuration illustrated, are useful in order to provide adequate fuel storage on board vehicle 12 when, for instance, a powertrain or vehicle component such as fame rail 16 or vehicle floor 18 extends through the space normally occupied by a fuel tank having a more standard shape (i.e. square, rectangular). It should be noted that the term “non-traditional” as used herein refers to a fuel tank 14 that defines, as a result of its cross-section, multiple measurable zones of fuel; as will be described below.

The fuel tank 14 may be constructed of sheet metal or a composite material defining a bottom 20, sides 22 and an upper surface or top portion 24. Disposed within the tank 14 is a fuel pump assembly 26 that, in the embodiment illustrated, is of the top mount, drop in type. Such a fuel pump assembly 26 includes a main body 28 that has a fuel intake 30 located adjacent a bottom portion thereof. The fuel pump assembly 26 is inserted into the fuel tank 14 though an opening 32 in the top portion 24 thereof, and the main body 28 is located such that the fuel intake 30 is positioned adjacent to the bottom 20; facilitating maximum usage of the fuel volume of the fuel tank. An assembly mount 34 supports the fuel pump assembly 26 in the fuel tank 14 and is operable to sealingly close the opening 32 of the tank 14.

A fuel level sensor assembly 36 is mounted on the main body of the fuel pump assembly 26 and includes a receiving unit 38, a first fuel level sensor 40 comprising a first swing arm 42 having a proximal end 43 pivotally mounted to the receiving unit and a distal end 44 having a float member 46 attached thereto. The first fuel level sensor 40 extends outwardly from the main body 28 of the fuel pump assembly 26 such that the float member 46 at the distal end 44 of the first swing arm is positioned to move with the level of fuel in a first or primary range 52 of the fuel tank volume 50. A second fuel level sensor 58 comprises a second swing arm 60 having a proximal end 62 pivotally mounted to the receiving unit 38 and a distal end 64 having a float member 66 attached thereto. The second fuel level sensor 58 extends outwardly from the main body 28 of the fuel pump assembly 26 such that the float member 66 at the distal end 64 of the second swing arm is positioned to move with the level of fuel in a second or preliminary range 54 of the fuel tank volume 50. In some embodiments, the primary range 52 and the preliminary range 54 of the fuel tank volume 50 may be mutually exclusive or, substantially mutually exclusive with only minor overlap.

During operation of the vehicle 12, an operator may fill the fuel tank 14 with fuel to a fill height 70 that signifies a full tank. The float member 66 fixed to the distal end 64 of the second swing arm 60 of the second fuel level sensor 58 is raised to the level of the fill height 70 of the preliminary range 54. Concurrently, the float member 46 fixed to the distal end of the first swing arm 42 of the first fuel level sensor 40 is raised to the upper level of the primary range 52. The receiving unit 38 delivers a signal to a control module 48 that indicates that the fuel level is within the preliminary range 54. The receiving unit signal may be comprised of a single, combined signal from both the first and the second fuel level sensors 40 and 58 or the signal may comprise individual signals from the first fuel level sensor 40 and the second fuel level sensor 58.

As fuel in the fuel tank 14 is drawn down by operation of the vehicle 12, the fuel level may drop below the preliminary range 54 and into the primary range 52. In such an instance, the second fuel level sensor 58 may reach a bottom or stop position that indicates the low height 72 of the preliminary range 54. Concurrently, the float member 46 fixed to the distal end of the first swing arm 42 of the first fuel level sensor 40 is drawn down through the primary range 52 by continued operation of the vehicle 12. The receiving unit 38 delivers a signal to control module 48 that indicates that the fuel level is within the primary range 52.

The application of multiple fuel level sensors to measure the fuel level in non-traditionally configured fuel tank 14 allows a constant fuel level reading to be provided to the vehicle operator and eliminates well known instances in which a fuel gage may remain immobile for an extended period of time and then rapidly drop as the measured volume is depleted.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

What is claimed is:

1. A fuel tank system for use in a vehicle comprising:
a fuel tank having a volume comprising a first or primary range and a second or preliminary range;
a fuel level sensor assembly disposed in the fuel tank comprising:
a receiving unit;
a first fuel level sensor positioned to move with the level of fuel in the first or primary range of the fuel; and
a second fuel level sensor positioned to move with the level of fuel in the second or preliminary range of the fuel, wherein the receiving unit delivers a signal to a control module that indicates that the fuel level is within the preliminary range or the primary range.

2. The fuel tank system of claim 1, wherein the primary range and the preliminary range of the fuel tank volume are mutually exclusive or, substantially mutually exclusive.

3. The fuel tank system of claim 1, the first fuel level sensor comprising a first swing arm having a proximal end pivotally mounted to the receiving unit and a distal end having a float member attached thereto and extending outwardly from the fuel level sensor assembly and into the first or primary range of the fuel volume.

4. The fuel tank system of claim 1, the second fuel level sensor comprising a second swing arm having a proximal end pivotally mounted to the receiving unit and a distal end having a float member attached thereto and extending outwardly from the fuel level sensor assembly and into the second or preliminary range of the fuel volume.

5. The fuel tank system of claim 1, wherein the receiving unit signal is comprised of a single, combined signal from both the first and the second fuel level sensors.

6. The fuel tank system of claim 1, wherein the receiving unit signal comprises individual signals from the first fuel level sensor and the second fuel level sensor.

7. A fuel tank system for use in a vehicle comprising:
a fuel tank having a fuel volume comprising a first or primary range and a second or preliminary range;
a fuel pump assembly disposed in the fuel tank and comprising a main body and a fuel level sensor assembly, the fuel level sensor assembly comprising:
a receiving unit;
a first fuel level sensor positioned to move with the level of fuel in the first or primary range of the fuel; and
a second fuel level sensor positioned to move with the level of fuel in the second or preliminary range of the fuel, wherein the receiving unit delivers a signal to a control module that indicates that the fuel level is within the preliminary range or the primary range.

8. The fuel tank system of claim 7, wherein the fuel tank further comprises a bottom, sides and a top portion.

9. The fuel tank system of claim 8, wherein the fuel pump assembly is inserted into the fuel tank though an opening in the top portion with the main body located adjacent the bottom to facilitate full usage of the fuel volume of the fuel tank.

10. The fuel tank system of claim 9, the fuel pump further comprising an assembly mount supporting the fuel pump assembly in the fuel tank and operable to sealingly close the opening in the top portion.

11. The fuel tank system of claim 7, wherein the first or primary range and the second or preliminary range of the fuel tank volume are mutually exclusive or, substantially mutually exclusive.

12. The fuel tank system of claim 7, wherein the receiving unit signal is comprised of a single, combined signal from both the first and the second fuel level sensors.

13. The fuel tank system of claim 7, wherein the receiving unit signal comprises individual signals from the first fuel level sensor and the second fuel level sensor.

14. A vehicle having a fuel tank system comprising:
a fuel tank having a fuel volume comprising a first or primary range and a second or preliminary range;
a fuel pump assembly disposed in the fuel tank and comprising a main body and a fuel level sensor assembly, the fuel level sensor assembly comprising:
a receiving unit;
a first fuel level sensor positioned to move with the level of fuel in the first or primary range of the fuel; and
a second fuel level sensor positioned to move with the level of fuel in the second or preliminary range of the fuel, wherein the receiving unit delivers a signal to a control module that indicates that the fuel level is within the preliminary range or the primary range.

15. The vehicle of claim 14, wherein the fuel tank further comprises a bottom, sides and a top portion.

16. The vehicle of claim 15, wherein the fuel pump assembly is inserted into the fuel tank though an opening in the top portion with the main body located adjacent the bottom to facilitate full usage of the fuel volume of the fuel tank.

17. The vehicle of claim 16, the fuel pump further comprising an assembly mount supporting the fuel pump assembly in the fuel tank and operable to sealingly close the opening in the top portion.

18. The vehicle of claim 14, wherein the primary range and the preliminary range of the fuel tank volume are mutually exclusive or, substantially mutually exclusive.

19. The vehicle of claim 14, wherein the receiving unit signal is comprised of a single, combined signal from both the first and the second fuel level sensors.

20. The vehicle of claim 14, wherein the receiving unit signal comprises individual signals from the first fuel level sensor and the second fuel level sensor.
